(19) United States
(12) Patent Application Publication
(10) Pub. No.: US 2024/0262317 A1
(43) Pub. Date: Aug. 8, 2024

(54) METHOD FOR OPERATING A PNEUMATIC SYSTEM, PNEUMATIC SYSTEM, VEHICLE

(71) Applicant: ZF CV Systems Global GmbH, Bern (CH)

(72) Inventors: Janik Ricke, Uetze (DE); Julian van Thiel, Grossburgwedel (DE)

(21) Appl. No.: 18/630,591

(22) Filed: Apr. 9, 2024

Related U.S. Application Data
(63) Continuation of application No. PCT/EP2022/076662, filed on Sep. 26, 2022.

(30) Foreign Application Priority Data
Oct. 12, 2021 (DE) 10 2021 126 341.7

(51) Int. Cl. B60S 1/54; B60S 1/56

(52) U.S. Cl. CPC B60S 1/54; B60S 1/56

(57) ABSTRACT

A method is for operating a pneumatic system for a vehicle. The pneumatic system includes a compressor for providing compressed air and at least one sensor cleaning device. The sensor cleaning device is configured to receive the compressed air and to provide it during an activation as compressed air flow for at least one cleaning nozzle. The method includes: operating the vehicle in a drive-free operating mode, in which the vehicle is in motion and is not significantly driven by a drive, switching on the compressor, and activating the at least one sensor cleaning device.

### CROSS-REFERENCE TO RELATED APPLICATIONS

This application is a continuation application of international patent application PCT/EP2022/076662, filed Sep. 26, 2022, designating the United States and claiming priority from German application 10 2021 126 341.7, filed Oct. 12, 2021, and the entire content of both applications is incorporated herein by reference.

### TECHNICAL FIELD

The disclosure relates to a method for operating a pneumatic system. The disclosure further relates to a pneumatic system for a vehicle, and a vehicle.

### BACKGROUND

Pneumatic systems for vehicles with a compressor for producing compressed air are well known. In particular, approaches are known in which the compressor is driven in a non-driven operating mode of the vehicle to use available energy to generate compressed air.

US 2012/0325327 already describes a pneumatic system in which the operation of the compressor can be supported in overrun phases by recovering kinetic energy from the vehicle without the use of fuel.

US 2013/0204472 describes a system for the recovery of braking energy, wherein compressed air can also be generated via an electric air charging system. A cut-off air pressure threshold can be increased under certain circumstances.

Despite these generally advantageous approaches, there is still room for improvement in systems and processes for better use and/or recovery of existing, especially kinetic, energy of the vehicle.

In particular, it is desirable to make better use of the potential of the available energy of the vehicle by converting it into pneumatic energy.

### SUMMARY

It is an object of the disclosure to specify a pneumatic system and a method for operating a pneumatic system that is improved with respect to at least one of the above problems. In particular, the aim is to make better use of the kinetic energy available in the vehicle.

The object is, for example, achieved by the disclosure in a first aspect via a method for operating a pneumatic system for a vehicle, wherein the pneumatic system has a compressor for providing compressed air and at least one sensor cleaning device, and the sensor cleaning device is configured to receive the compressed air and, when activated, to provide it as a compressed air flow for at least one cleaning nozzle. The method including: operating the vehicle in a non-driven operating mode in which the vehicle is in motion and is not significantly driven by a drive; switching on the compressor; and, activating the at least one sensor cleaning device.

The disclosure is based on a method for operating a pneumatic system for a vehicle, wherein the pneumatic system has a compressor to provide compressed air and at least one sensor cleaning device, and the sensor cleaning device is configured to receive the compressed air and, when activated, to provide it as a compressed air flow for at least one cleaning nozzle, wherein the method has the following steps: Operating the vehicle in a non-driven operating mode, in which the vehicle is in motion and is not significantly driven by a drive; Switching on the compressor. “Not significantly driven” means, in particular, that no driving engine torque is provided by the drive.

According to the disclosure, the method involves the step: Activating the at least one sensor cleaning device.

The disclosure is based on the knowledge that the use of available, in particular kinetic, energy of a vehicle in different forms of energy is fundamentally advantageous. The disclosure has recognized that via a pneumatic system, the energy available in a non-driven operating mode can also be used in pneumatic form, that is, it can be converted into pneumatic energy.

The disclosure includes the realization that the possibilities for using the available kinetic energy are advantageously expanded by the use of additional pneumatic consumers, which can be operated sensibly even when the kinetic energy is available. Here the disclosure has recognized that a sensor cleaning device counts as such an additional pneumatic consumer.

In particular, a compressed air accumulator is not necessarily required for the sensible use of a sensor cleaning device in the context of the use of available kinetic energy. Rather, in a non-driven operating mode, when the activation condition is met, the sensor cleaning device can be activated in order to use the kinetic energy available in the vehicle, which is converted into pneumatic energy by switching on the compressor, directly and in particular without additional requirements for further buffer storage.

By activating the sensor cleaning device in the non-driven operating mode, available kinetic energy of the vehicle is advantageously converted into compressed air and used to clean at least one sensor surface. This provides an advantageous cleaning and/or drying effect, which ensures the function of the sensors and increases the safety and/or driving comfort of the vehicle.

As part of an embodiment of the method, it is envisaged that the switching on of the compressor and/or the activation of the at least one sensor cleaning device will be carried out within the framework of predetermined pressure conditions. It is preferable to check whether the predetermined pressure conditions are met in the non-driven operating mode.

By switching on the compressor and/or activating the at least one sensor cleaning device within predetermined pressure conditions, it is possible to ensure that the beneficial use of kinetic energy takes place under conditions that are not detrimental to the vehicle. Preferably, the predetermined pressure conditions concern a pneumatic system of the vehicle, particularly preferably a pressure accumulator that is installed in the vehicle. The embodiment has recognized that switching on the compressor leads to an increase in pressure, especially the accumulator pressure, and activating the at least one sensor cleaning device leads to a drop in pressure, especially the accumulator pressure.

Preferably, it can be envisaged that the predetermined pressure conditions include a compressor switch-on condition. Preferably, the compressor switch-on condition is met if an accumulator pressure is not greater than an upper cut-off pressure, which is preferably a technically determined maximum filling limit of the compressed air accumulator. In particular, the compressor is switched on when the compressor switch-on condition is met. The embodiment has recognized that excessive pressure, especially accumulator pressure, is detrimental to the condition of the pneumatic system, especially of a pressure accumulator. In particular, the upper cut-off pressure represents a limit value, exceeding which must be avoided from a technical point of view, in particular in order to avoid any damage to the compressed air accumulator and/or the pneumatic system.

Preferably, it is envisaged that the predetermined pressure conditions include an activation condition. Preferably, the activation condition is met if an accumulator pressure in a compressed air accumulator pneumatically connected to the compressor is greater than an activation pressure. In particular, the sensor cleaning device is activated when the activation condition is met. The embodiment has recognized that too low a pressure, especially an accumulator pressure, is detrimental to the availability of compressed air in the vehicle.

This means, in particular, that in this embodiment in order to meet the activation condition, both the vehicle must be in a non-driven operating mode and the accumulator pressure must be greater than an activation pressure. This embodiment is advantageous in avoiding situations in which the kinetic energy available in the non-driven operating mode is made available to the sensor cleaning device despite a low accumulator pressure. Rather, in such a case, this existing kinetic energy is used to fill the compressed air accumulator. Advantageously, the activation pressure is in a range of 9.5 bar to 13.5 bar, preferably in a range of 10.5 bar to 12.5 bar, and the activation pressure is particularly preferably 11.5 bar.

In the context of another embodiment, it is envisaged that the activation pressure will be a lower cut-off pressure that is lower than the upper cut-off pressure. Compared to the upper cut-off pressure, the lower cut-off pressure is a pressure limit that is a defined amount below the upper cut-off pressure, and in particular represents a cut-off pressure for the compressor under normal conditions, that is, when the available kinetic energy is not used. In normal operation, at least in the target state, the compressed air accumulator is always filled to the lower cut-off pressure. The range between the lower and upper cut-off pressures thus represents an additional pneumatic buffer capacity that can be used for a pneumatic conversion of the kinetic energy available in the non-driven operating mode, and can be provided particularly advantageously for the sensor cleaning device in the form of compressed air. By using a compressed air accumulator and operating the pneumatic system within predetermined pressure conditions with an upper and lower cut-off pressure, the temporal flexibility in the use of the kinetic energy available in the non-driven operating mode by the sensor cleaning device can be advantageously increased. Advantageously, the upper cut-off pressure is in a range of 11.5 bar to 15.5 bar, preferably in a range of 12.5 bar to 14.5 bar, and the upper cut-off pressure is particularly 13.5 bar. The lower cut-off pressure is advantageously in a range of 10.5 bar to 14.5 bar, preferably in a range of 11.5 bar to 13.5 bar, and the lower cut-off pressure is particularly preferably 12.5 bar.

It is preferably provided that the compressor switch-on condition is met, that is, the compressor is switched on, when a falling accumulator pressure has reached the lower cut-off pressure. It is preferably provided that the compressor switch-on condition is no longer met, that is, the compressor is switched off, when an increasing accumulator pressure has reached the upper cut-off pressure.

It is advantageously provided that the activation pressure is a dynamically determined activation pressure, preferably determinable on the basis of a predicted thrust duration of the non-driven operating mode. Using operating data of the vehicle and/or a navigation device, in such an embodiment it is possible to predict how long the vehicle will be in a non-driven operating mode, in particular an overrun mode, as an estimate. If, for example, there is a longer downward distance ahead, the activation pressure can be selected correspondingly low, since a longer phase of available kinetic energy can be assumed. Therefore, in such a case, it can be assumed that sufficient compressed air can be generated to supply the sensor cleaning device on the one hand, but also to supply other pneumatic consumers on the other, preferably to fill up a compressed air accumulator.

The disclosure is further developed by the fact that the non-driven operating mode is an overrun mode in which the drive is driven by a driving movement of the vehicle, or the non-driven operating mode is a deceleration mode in which the vehicle is decelerated via a deceleration request. According to the concept of the disclosure, if the non-driven operating mode is a deceleration mode, the method has the advantage of producing a braking effect by converting the kinetic energy into pneumatic energy.

In a non-driven operating mode, no drive torque is transmitted to the vehicle by the drive, but the driving movement is generated by the inertia of the vehicle and/or the gravity acting on the vehicle during a journey downhill. In various embodiments, no drive torque is requested in the non-driven operating mode. According to the concept of the disclosure, the kinetic energy available in this way can be used advantageously by switching on the compressor and/or activating the sensor cleaning device. In overrun mode, there is in particular a tractional connection between the vehicle, in particular its wheels, and the drive, that is, the vehicle rolls with a gear engaged. Overrun operation can be advantageously determined by the electronic control unit using the operating data of the vehicle, preferably by determining a state in which no drive torque is requested but a gear is engaged.

Preferably, switching on the compressor involves engaging the compressor via a coupling device, especially preferably to a drive or another component driven by a vehicle movement. Alternatively or additionally, switching on the compressor may include electronic control of an electrically or electronically driven compressor.

In the context of an embodiment, it is envisaged that the activation of the at least one sensor cleaning device requires the opening of a valve, preferably a solenoid valve, which contains the at least one sensor cleaning device. By opening the valve, at least one sensor surface assigned to the sensor cleaning device can advantageously be subjected to compressed air for cleaning.

As part of an embodiment, it is envisaged that the compressor will be operated in a throttled compressor mode. In particular, the throttled compressor mode is such that an instantaneous compressed air flow rate of the compressor providing compressed air is approximately equal to the instantaneous compressed air consumption rate of the at least one sensor cleaning device. The throttled compressor mode can be implemented in different ways. In the case of an electrically driven compressor, this can be achieved in particular by controlling the electric motor driving the compressor. Within the scope of the disclosure, a throttled compressor mode characterizes a compressor with an adjustable flow rate. In the case of a mechanical compressor, driven in particular via a coupling device, a throttled compressor mode can be implemented via a gearbox or suitable pneumatic actuators such as throttle valves.

The disclosure leads for the achievement of the above object in a second aspect to a pneumatic system for a vehicle, having a compressor configured to provide compressed air, at least one sensor cleaning device configured to receive the compressed air and, when activated, to provide it as a compressed air flow for at least one cleaning nozzle, and an electronic control unit configured to control the compressor and/or the sensor cleaning system, wherein the vehicle is operable in a non-driven operating mode, in which the vehicle is in motion and is not significantly driven by a drive of the vehicle, and the electronic control unit is configured to switch on the compressor in the non-driven operating mode. In the case of the pneumatic system according to the second aspect of the disclosure, it is envisaged that the electronic control unit is configured to activate the at least one sensor cleaning device in the non-driven operating mode. In particular, the electronic control unit is configured to activate the compressor and/or activate the at least one sensor cleaning device within the framework of predetermined pressure conditions.

In an embodiment of the pneumatic system, it is envisaged that the at least one sensor cleaning device has a valve, preferably a switching valve, particularly preferably a solenoid valve that can be switched or preferably opened to activate the sensor cleaning device.

In a further embodiment of the pneumatic system, it is envisaged that the valve is configured to direct the compressed air to the cleaning nozzle as a continuous flow of compressed air, preferably past a pulse valve of the sensor cleaning device, wherein the activation of the sensor cleaning device involves opening the valve.

The disclosure leads for the achievement of the above object in a third aspect to a vehicle, preferably a commercial vehicle or passenger car, having a pneumatic system according to the second aspect of the disclosure and/or an electronic control unit configured to carry out a method according to the first aspect of the disclosure.

### BRIEF DESCRIPTION OF DRAWINGS

The invention will now be described with reference to the drawings wherein:

FIG. 1 shows a first embodiment of a vehicle in accordance with the concept of the disclosure;

FIG. 2 shows a second embodiment of a vehicle in accordance with the concept of the disclosure; and,

FIG. 3 shows a schematic diagram showing a profile of an accumulator pressure as well as the operating state of a compressor and of a sensor cleaning device as a function of time T for an unspecified vehicle in accordance with the concept of the disclosure.

### DETAILED DESCRIPTION

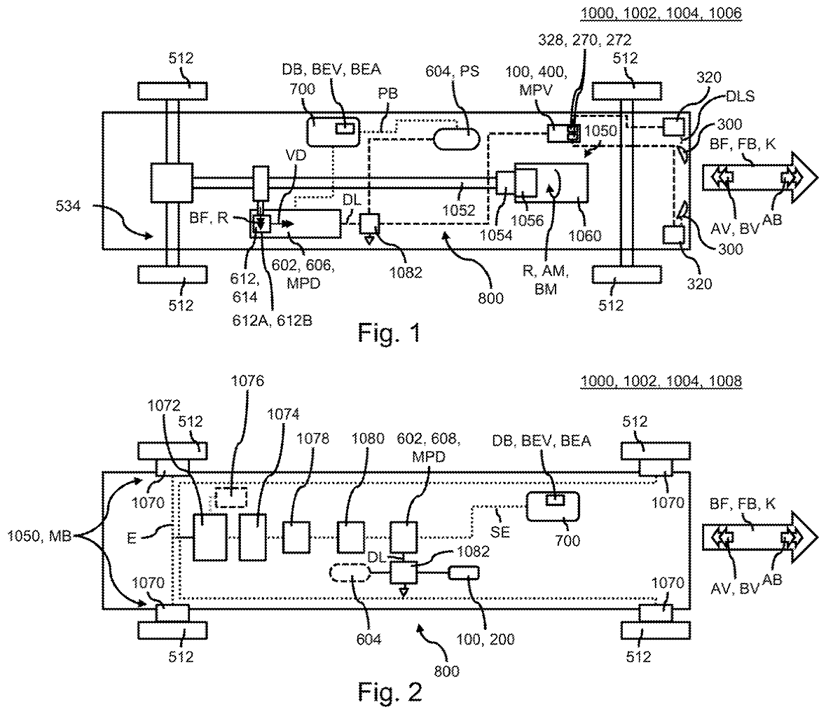

FIG. 1 shows a vehicle 1000 in the form of a commercial vehicle 1002 with a pneumatic system 800 according to the concept of the disclosure. Nevertheless, in the context of the disclosure, the vehicle 1000 may have a different configuration, for example as a passenger car 1004.

The vehicle 1000 has a drive 1050 with a combustion engine 1060 and is therefore a combustion vehicle 1006.

The drive 1050 is configured to generate a rotational movement R and to transmit it to wheels 512 via a drive shaft 1052, in the present case two wheels 512 of a rear axle 534 of the vehicle 1000, in order to generate the driving movement FB. The actuator 1050 also has a gearbox 1056 for selectively adjusting a gear ratio of the rotational motion R, and a drive coupling 1054 for selectively disconnecting the transmission of the rotational motion R.

The pneumatic system 800 has a compressor 602 for generating and supplying compressed air DL. In the present case, the compressor 602 is in the form of a mechanically driven compressor 606 and can be selectively coupled to the drive 1050, in this case via the drive shaft 1052, via a coupling device 612. The pneumatic system 800 also has a compressed air accumulator 604, which is configured to receive and store the compressed air DL. The compressed air accumulator 604 is pneumatically connected to the compressor 602 via a multi-circuit protection valve 1082. Nevertheless, other embodiments are possible within the scope of the disclosure in which the pneumatic system 800 of a vehicle 1000 does not have a compressed air accumulator 604.

The vehicle 1000 has a sensor cleaning system 200 with a sensor cleaning device 100. The sensor cleaning device 100 is pneumatically connected or connectable to the compressor 602 via the multi-circuit protection valve 1082. In the present case, the sensor cleaning device 100 is in the form of a sensor cleaning central module 400 for supplying cleaning nozzles 320 with compressed air DL, and possibly other cleaning media such as cleaning fluid. Two cleaning nozzles 320 are shown here as examples. In other embodiments, the sensor cleaning system 200 can have multiple sensor cleaning devices 100.

The vehicle 1000 has an electronic control unit 700 configured to control the compressor 602 and/or the sensor cleaning system 200.

In a driven operating mode BM, the vehicle 1000 is driven by the drive 1050. In the driven operating mode BM, the drive 1050, in this case the internal combustion engine 1060, generates a drive torque AM and transmits it to the wheels 512 via the drive shaft 1052 to generate the driving movement FB.

In a non-driven operating mode BF of the vehicle 1000, the vehicle 1000 is in motion, but is not significantly driven by the drive 1050. In the non-driven operating mode BF, the driving movement FB is caused in particular by a mass inertia of the vehicle 1000 and/or—if the vehicle is moving 1000 downhill—by the gravity of the earth. In this state, the vehicle 1000 has kinetic energy K. In particular, the non-driven operating mode BF is an overrun mode BS in which the drive coupling 1054 is in the closed state. In the non-driven operating mode BF, there is in particular no acceleration request AB, that is, in particular no drive torque AM is requested from the combustion engine 1060 and/or from the drive 1050. In the non-driven operating mode BF, there may be a deceleration mode BV in particular, in which the vehicle 1000 is decelerated via a deceleration request AV. In particular, the deceleration request AV can be applied to a braking system that is not shown here. The electronic control unit 700 is configured to switch on the compressor 602 and/or activate the sensor cleaning device 100 under predetermined pressure conditions DB.

The vehicle 1000 is configured to switch on the compressor 602 via the electronic control unit 700 for the generation of compressed air DL in the non-driven operating mode BF by switching the coupling device 612 to a closed state 612A if a compressor switch-on condition BEV is met. As is the case here, the compressor switch-on condition BEV is preferably met if an accumulator pressure PS in the compressed air accumulator 604 is less than or equal to an upper cut-off pressure PAO, which is a technically determined maximum filling limit PMAX of the compressed air accumulator 604. This means that the compressor 602 is switched off by switching the coupling device 612 to an open state 612B when the accumulator pressure PS has reached a critical maximum value in the form of the upper cut-off pressure PAO. In this way, the energy available during a non-driven operating mode BF can be advantageously used to provide compressed air DL for supplying the at least one sensor cleaning device 100 and/or for filling the compressed air accumulator 604.

The vehicle 1000 is further configured to activate the sensor cleaning device 100 via the electronic control unit 700 depending on an activation condition BEA, preferably if the compressor switch-on condition BEV is also met. It is particularly preferable for the electronic control unit 700 to activate the sensor cleaning device 100 if the activation condition BEA is met and to deactivate the sensor cleaning device 100 if the activation condition BEA is not met.

If the at least one sensor cleaning device 100 is activated, in particular a switching valve 270 of the sensor cleaning device 100 is open, the compressed air DL is provided to the cleaning nozzle 320 for the purpose of cleaning a sensor surface 300. To selectively supply the compressed air DL to the cleaning nozzle 320, the sensor cleaning device 100 has a valve 328, preferably a switching valve 270, particularly preferably a solenoid valve 272 as shown here. The cleaning nozzle 320 is arranged and configured to direct the provided compressed air DL as a compressed air flow DLS to the sensor surface 300 for cleaning. The compressed air flow DLS can be approximately constant or have a different shape or profile, for example it may be pulsed. The solenoid valve 272 can be in the form of a 2/2-way valve, or of another valve, such as a 3/2-way valve. Advantageously, the pneumatic system 800 is configured in such a way that an instantaneous compressed air flow rate MPD of the compressor 602 providing the compressed air DL corresponds to an instantaneous compressed air consumption rate MPV of the sensor cleaning device 100. In particular, this means that the at least one sensor cleaning device 100 consumes approximately as much, or at least as much, compressed air DL as is provided by the compressor 602. The instantaneous compressed air flow rate MPD and the instantaneous compressed air consumption rate MPV can be stated as mass or volume data, or mass or volume against time data.

Preferably, the compressor 602 is configured to be operated in a throttled compressor mode VD. In a throttled compressor mode VD, the instantaneous compressed air flow rate MPD can be adjusted, preferably to a currently required quantity, especially preferably to the instantaneous compressed air consumption rate MPV. For this purpose, the compressor 602 can preferably be electrically controllable, or adjustable via a gearbox or similar control device. Signal-carrying and/or electrical cables are dotted in the figures, compressed air lines are shown dashed.

FIG. 2 shows another embodiment of a vehicle 1000 in the form of an electric vehicle 1008. The vehicle 1000 can be in the form of a passenger car 1002 or of a commercial vehicle 1004 or of another vehicle 1000. In contrast to the embodiment shown in FIG. 1, the vehicle 1000 shown here has a drive 1050 with a number of electric motors 1070. In the present case, an electric motor 1070 is arranged on each wheel 512. Each electric motor is configured to transmit a drive torque AM to the wheel 512 assigned to it. Nevertheless, in other embodiments, a central electric motor 1070 can be provided, which, for example, transmits a drive torque AM to one or more wheels 512 via a drive shaft 1052—as shown in FIG. 1—to generate a driving movement FB. The vehicle 1000 is equipped with a traction battery 1072, which is electrically connected to the electric motors 1070 for the purpose of supplying electrical energy. The traction battery 1072 is also connected to an on-board power supply battery 1080 via an inverter 1074 and a voltage converter 1078. The voltage converter 1078 is in the form of a high/low voltage DC converter that can convert a high DC voltage, such as 400 V, to a low DC voltage, such as 12 V or 24 V or 48 V. The on-board battery 1080 stores electrical energy at a relatively low DC voltage, such as 12 V or 24 V or 48 V.

The vehicle 1000 also has a pneumatic system 800, which contains a compressor 602 in the form of an electric compressor 608. The electric compressor 608 is supplied with electrical energy by the on-board power supply battery 1080.

The pneumatic system 800 also contains a multi-circuit protection valve 1082 through which the at least one sensor cleaning device 100 is pneumatically connected, similarly to the embodiment shown in FIG. 1. The sensor cleaning device 100 is illustrated in a very simplified way for better clarity. For further details, such as switching valves and cleaning nozzles, refer to FIG. 1.

In optional embodiments, the vehicle 1000 can have a fuel cell 1076 for generating electrical energy, as shown here dashed. In optional embodiments, the pneumatic system 800 can have a compressed air accumulator 604 for storing compressed air DL.

Similarly to the embodiment shown in FIG. 1, the vehicle 1000 can be operated in a driven operating mode BM and a non-driven operating mode BF. In a driven operating mode BM, the vehicle 1000 is powered by the drive 1050. In the driven operating mode BM, the drive 1050, in this case the electric motors 1072, generates a drive torque AM and transmits it via the wheels 512 to generate the driving movement FB.

In a non-driven operating mode BF of the vehicle 1000, the vehicle 1000 is in motion but is not powered by the drive 1050. In this state, the vehicle 1000 has a kinetic energy K. In the non-driven operating mode BF, the driving movement FB is caused in particular by a mass inertia of the vehicle 1000 and/or—if the vehicle 1000 is moving downhill—by the gravity of the earth. In particular, the non-driven operating mode BF is an overrun mode BS. In the non-driven operating mode BF, there is in particular no acceleration request AB, that is, in particular no drive torque AM is requested from the combustion engine 1060 and/or from the drive 1050. In the non-driven operating mode BF, there may be a deceleration mode BV in particular, in which the vehicle 1000 is decelerated via a deceleration request AV. In particular, the deceleration request AV can be applied to a braking system not shown here and/or to the electric motors 1072. If the deceleration request AV is applied to the electric motors 1072, they can be operated as electric generators via appropriate control and while generating a braking effect can generate electrical energy and provide it to the traction battery 1072.

Compared to FIG. 1, the electrically driven compressor 608 is not mechanically, but electrically, coupled to the drive 1050 in the present embodiment. In the non-driven operating mode BF, electrical energy E can be supplied, preferably to the traction battery 1072, via the electric motors 1072 operated as electric generators. The energy available in the non-driven operating mode BF is thus not made available directly to the electrically driven compressor 608 in the form of rotational motion R, but in electrical form for the generation of compressed air DL. In particular, this can be done independently of an energy storage system, such as the traction battery 1072 or the on-board power supply battery 1080. However, it is also possible that the electrical energy available in the non-driven operating mode BF is temporarily stored in the traction battery 1072 and/or the on-board power supply battery 1080. Checking the predetermined pressure conditions DB, in particular the compressor switch-on condition BEV and/or the activation condition BEA, as well as the control of the compressor 602, are preferably carried out by the electronic control unit 700. In the case of an electrically driven compressor 608, a throttled compressor mode VD can be advantageously implemented with relatively little effort, especially via appropriate control.

The vehicle 1000 is further configured to activate the sensor cleaning device 100 via the electronic control unit 700 depending on an activation condition BEA, preferably if the compressor switch-on condition BEV is also met. Particularly preferably, the electronic control unit 700 is configured to activate the sensor cleaning device 100 if the activation condition BEA is met and to deactivate the sensor cleaning device 100 if the activation condition BEA is not met.

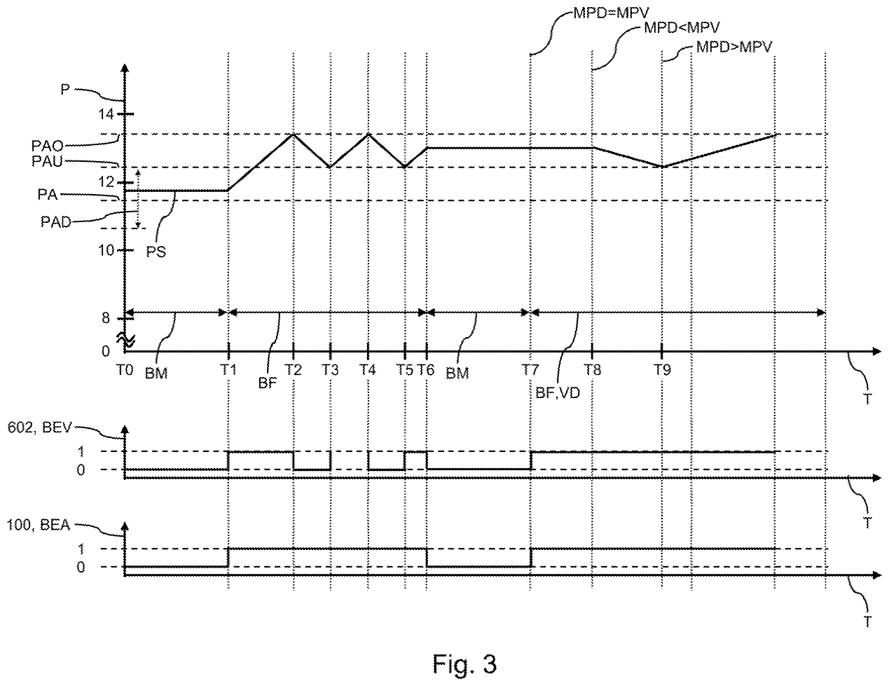

FIG. 3 shows a schematic diagram showing a curve of an accumulator pressure PS and the operating state of a compressor 602 and a sensor cleaning device 100 as a function of time T for an unspecified vehicle 1000. At an initial point in time T0, the accumulator pressure PS is above the activation pressure PA, approx. at 11.8 bar. The vehicle 1000 is in the driven operating mode BM at this time. In various embodiments, the activation pressure PA can be a dynamically determined activation pressure PAD, which is preferably variably determined as a function of a predicted thrust duration DS of the non-driven operating mode BF.

At a first point in time T1, the vehicle changes from the driven operating mode BM to the non-driven operating mode BF. The compressor switch-on condition BEV is met because the vehicle 1000 is in the non-driven operating mode BF and the accumulator pressure PS is below an upper cut-off pressure PAO. Consequently, the compressor 602 is switched on, as illustrated here with the binary signal which switches to the value 1. The activation condition BEA is also met because the vehicle 1000 is in the non-driven operating mode BF and the accumulator pressure PS is above the activation pressure PA. Consequently, the sensor cleaning device 100 is activated in order to apply the compressed air DL generated by the compressor 602 to at least one sensor surface 300. The activation of the sensor cleaning device 100 is also illustrated with a binary signal that switches to the value 1.

At a second point in time T2, the accumulator pressure PS has reached the upper cut-off pressure PAO of approx. 13.5 bar. In order to prevent a further increase in the accumulator pressure PS and in particular damage to the pneumatic system 800, the compressor switch-on condition BEV is no longer met and consequently the compressor 602 is switched off. The sensor cleaning device 100, on the other hand, remains activated because the activation condition BEA is still met.

At a third point in time T3, the accumulator pressure PS has reached the lower cut-off pressure PAU of approx. 12.5 bar, which means that the compressor switch-on condition BEV is met again and the compressor 602 is switched on. The activation condition BEA is still met and consequently the sensor cleaning device 100 remains activated.

This oscillation between upper and lower cut-off pressures PAO, PAU is repeated up to a fifth point in time T5 and beyond, until at a sixth point in time T6 the vehicle 1000 changes back to the driven operating mode BM. The compressor switch-on condition BEV is no longer met, which causes the compressor 602 to be switched off. The activation condition BEA is also no longer met, whereby the sensor cleaning device 100 is deactivated. As a result, the accumulator pressure PS remains constant at a value of approximately 13 bar.

At a seventh point in time T7, the vehicle 1000 changes back to the non-driven operating mode BF, wherein the compressor switch-on condition BEV and the activation condition BEA are met. At the seventh point in time T7, an instantaneous compressed air flow rate MPD is provided by the compressor 602 via a throttled compressor mode VD, which is approximately equivalent to the compressed air consumption rate MPV currently required by the sensor cleaning device 100. As a result, the accumulator pressure PS remains approximately constant.

At an eighth point in time T8, the compressed air flow rate MPD is adjusted in such a way that it is lower than the currently required air consumption rate MPV. As a result, the accumulator pressure PS decreases. At a ninth point in time T9, the compressed air flow rate MPD is adjusted in such a way that it is higher than the currently required compressed air consumption rate MPV, whereby the accumulator pressure PS consequently increases. This is intended to illustrate that via a throttled compressor mode VD, an accumulator pressure can be adjusted as desired or preferably kept constant without having to switch the compressor 602 on or off frequently.

The activation pressure PA represents a minimum threshold below which the sensor cleaning device 100 is not activated within the framework of the method according to the concept of the disclosure in order not to let the accumulator pressure PS drop too much. Nevertheless, it is of course possible to activate the sensor cleaning device 100—regardless of the method according to the concept of the disclosure.

It is understood that the foregoing description is that of the preferred embodiments of the invention and that various changes and modifications may be made thereto without departing from the spirit and scope of the invention as defined in the appended claims.

### REFERENCE SIGN LIST (PART OF THE DESCRIPTION)

100 Sensor cleaning device

200 Sensor cleaning system

328 Valve

270 Switching valve

272 Solenoid valve

300 Sensor surface

320 Cleaning nozzle

400 Sensor cleaning central module

512 Wheel

534 Rear axle

602 Compressor

604 Compressed air accumulator

606 Mechanically driven compressor

608 Electrically driven compressor

612 Coupling device

612A Closed state of the coupling device

612B Open state of the coupling device

700 Electronic control unit

800 Pneumatic system

1000 Vehicle

1002 Commercial vehicle

1004 Passenger car

1006 Combustion Vehicle

1008 Electric vehicle

1050 Drive

1052 Drive shaft

1054 Drive coupling

1056 Gearbox

1060 Internal combustion engine

1070 Electric motor

1072 Traction battery

1074 Inverter

1076 Fuel cell

1078 Voltage Converter, DC/DC High/Low Voltage-Voltage Converter

1080 On-board power supply battery

1082 Multi-circuit protection valve

AB Acceleration request

AM Drive torque

AV Deceleration request

BEA Activation condition

BEV Compressor switch-on condition

BF Non-driven operating mode

BM Driven operating mode

BS Overrun operating mode

BV Deceleration operation

DB Predetermined pressure conditions

DL Compressed air

DLS Compressed air flow

E Electrical energy

FB Driving movement

K Kinetic energy

MPD Compressed air flow rate

MPV Compressed air consumption rate

PA Activation pressure

PAO Upper cut-off pressure

PAU Lower cut-off pressure

PMAX Maximum filling limit

PS Accumulator pressure

R Rotational motion

T Time

T0 Initial point in time

T1 to T9 first to ninth points in time

VD Throttled compressor operation

1. A method for operating a pneumatic system for a vehicle, wherein the pneumatic system has a compressor for providing compressed air and at least one sensor cleaning device, and the sensor cleaning device is configured to receive the compressed air and, when activated, to provide it as a compressed air flow for at least one cleaning nozzle, the method comprising:
operating the vehicle in a non-driven operating mode in which the vehicle is in motion and is not significantly driven by a drive;
switching on the compressor; and,
activating the at least one sensor cleaning device.

2. The method of claim 1, wherein at least one of said switching on of the compressor and said activation of the at least one sensor cleaning device is carried out within the framework of predetermined pressure conditions.

3. The method of claim 2, wherein the predetermined pressure conditions include a compressor switch-on condition, wherein the compressor switch-on condition is met when an accumulator pressure is not greater than an upper cut-off pressure.

4. The method of claim 3, wherein the upper cut-off pressure is a technically determined maximum filling limit of a compressed air accumulator.

5. The method of claim 2, wherein the predetermined pressure conditions include an activation condition, wherein the activation condition is met if an accumulator pressure in a compressed air accumulator pneumatically connected to the compressor is greater than an activation pressure.

6. The method of claim 5, wherein the activation pressure is a lower cut-off pressure lower than an upper cut-off pressure, which is a technically determined maximum filling limit of the compressed air accumulator.

7. The method of claim 5, wherein the activation pressure is a dynamically determined activation pressure.

8. The method of claim 7, wherein the activation pressure is determinable via a predicted thrust duration of the non-driven operating mode.

9. The method of claim 1, wherein:
the non-driven operating mode is an overrun mode in which the drive is driven by a driving movement of the vehicle; or,
the non-driven operating mode is a deceleration mode in which the vehicle is decelerated via a deceleration request.

10. The method of claim 1, wherein said activating at least one sensor cleaning device includes opening a valve which contains the at least one sensor cleaning device.

11. The method of claim 10, wherein the valve is a solenoid valve.

12. The method of claim 1, wherein the compressor is operated in a throttled compressor mode.

13. The method of claim 1, wherein the compressor is operated in a throttled compressor mode in such a way that an instantaneous compressed air flow rate of the compressor providing compressed air is equal to an instantaneous compressed air consumption rate of the at least one sensor cleaning device.

14. A pneumatic system for a vehicle, the pneumatic system comprising:
a compressor configured to provide compressed air;
at least one sensor cleaning device configured to receive the compressed air and, when activated, to provide it as a compressed air flow for at least one cleaning nozzle;
an electronic control unit configured to control at least one of said compressor and a sensor cleaning system;
wherein the vehicle is operable in a non-driven operating mode in which the vehicle is in motion and is not significantly driven by a drive of the vehicle;
said electronic control unit being configured to switch on said compressor in the non-driven operating mode; and,
said electronic control unit being configured to activate said at least one sensor cleaning device in the non-driven operating mode.

15. The pneumatic system of claim 14, wherein said at least one sensor cleaning device has a valve configured to be switched or opened to activate said at least one sensor cleaning device.

16. The pneumatic system of claim 15, wherein said valve is at least one of a switching valve and a solenoid valve.

17. A vehicle comprising the pneumatic system of claim 14.

18. The vehicle of claim 17, wherein the vehicle is a commercial vehicle or a passenger car.

19. A vehicle comprising an electronic control unit configured to carry out the method of claim 1.
